(19) United States
(12) Patent Application Publication
(10) Pub. No.: US 2026/0285255 A1
(43) Pub. Date: Sep. 24, 2026

(54) CONTROL DEVICE FOR A WINDSHIELD WIPER SYSTEM

(71) Applicant: Robert Bosch GmbH, Stuttgart (DE)

(72) Inventors: Manuel Hans Reith, Lauf (DE); Michael Kruse, Sinzheim (DE); Florian Tisch, Renchen-Ulm (DE)

(21) Appl. No.: 18/996,079

(22) PCT Filed: Jul. 18, 2023
(86) PCT No.: PCT/EP2023/069870

§ 371 Date: Jan. 17, 2025

(30) Foreign Application Priority Data
Jul. 21, 2022 (DE) 10 2022 207 459.9

(51) Int. Cl. B60S 1/08

(52) U.S. Cl. CPC B60S 1/08

(57) ABSTRACT

The invention relates to a control device (160) for controlling a windshield wiper system (100), comprising a computing unit (16), a nonvolatile memory unit (18), and a programming interface (19) via which a program stored in the nonvolatile memory unit (18) can be modified. The invention also relates to a method for programming a control device (160) of this kind, wherein a programming device (200) is connected to the programming interface (19) for data transmission and the program stored in the nonvolatile memory unit (18) is modified while the control device (160) is installed in a vehicle.

### BACKGROUND

The present invention relates to a control device for controlling a windshield wiper system, in particular a windshield wiper system for a vehicle. Furthermore, the invention relates to a method for programming such a control device, as well as a programming device and a computer program for carrying out the same.

Windshield wipers are used in various types of vehicles, among others as front and rear windshield wipers in motor vehicles. Typical windshield wiper systems include one or more wiper arms provided with wiper blades, which are moved cyclically over the windshield to be cleaned to wipe moisture from the windshield. An electronically controlled electric motor, typically a rotating motor, whose movement is converted to the desired wiping movement either directly or via a corresponding transmission, serves as the drive for a wiper arm.

### SUMMARY

According to the invention, a method, a control device for controlling a windshield wiper system, in particular a windshield wiper system for a vehicle, a method for programming such a control device, and a programming device and a computer program for carrying out the same are proposed with the features of the independent claims. Advantageous embodiments are the subject of the dependent claims and the following description.

The invention presents a possibility of subsequently enabling a safe, selective activation of wiper functions.

Due to the increasing number of technical systems or modules in the vehicle, it is becoming increasingly likely that vehicles will be technically capable of providing additional wiper functions-for example comfort functions-in addition to the standard wiper functions that they are intended to realize. This capability can for example, only be recognized retrospectively (e.g., the additional wiper function only becomes relevant later) or not be requested by the buyer of the vehicle (the buyer does not want the additional vehicle function in the vehicle). Retrofitting of the vehicle with new wiper functions is currently provided.

In the context of the invention, however, it is now proposed to be able to activate such functions subsequently by modifying the programming of the control device for controlling a windshield wiper system when it is already installed in the vehicle. To this end, the control device comprises a computing unit, such as a CPU, a microprocessor, a microcontroller, or the like, a nonvolatile memory unit, such as a flash memory, as well as a programming interface via which a program stored in the memory unit can be modified. The control device is in particular configured to allow the program stored in the memory unit to be modified while the control device is installed in a vehicle.

Modifying the program stored in the memory unit includes, in particular, activating or enabling a wiper function previously already included in the program. In this configuration, the wiping function is already stored in the saved program, but has not yet activated and thus cannot be executed. For example, a register memory may be provided in which executable wiper functions are defined with a so-called flag, which is set by modifying the program stored in the memory unit. In this respect, the content of the register memory is part of the stored program. The programming requirements are particularly low here, in the simplest case only one bit has to be modified.

Modifying the program stored in the memory unit also includes, in particular, adding program code of a wiping function to the program stored in the memory unit. This includes, in particular, adding a wiper function not previously included in the program or updating/upgrading such a wiper function. In this configuration, the wiper function is subsequently stored in the saved program or updated there in the course of an update or upgrade. This can also be used to implement functions that are not yet known.

Both variants can also be combined, i.e., wiper functions may be added (or updated) subsequently, wherein the executability of a wiper function is still generally defined by flags or the like.

According to one embodiment, a wiper function that can be activated subsequently includes, in particular, a zone cleaning of sensors, a power splash wiping, tear wiping, a dirt wedge wiping, and a predictive maintenance that can be used to generate an automatic warning of a predictable failure (wear).

According to one embodiment, the program stored in the memory unit also includes activated wiping functions by default, which are already available in the original state after initial programming. These include in particular regular wiping functions such as continuous wiping and interval wiping, each with different wiping frequencies. This ensures that wiping functions that are relevant or prescribed for safety are always available.

According to one embodiment, the program stored in the memory unit contains at least one deactivated wiping function, which can, however, be subsequently activated by modifying the program. According to a further embodiment, the program stored in the nonvolatile memory unit contains at least one activated wiping function that has been activated by modifying the program stored in the nonvolatile memory unit. This limits the amount of programming to be carried out and the amount of data to be transferred during the modification of the program.

According to one embodiment, at least one of the wiping functions activated by default cannot be deactivated by changing the program stored in the memory unit. In particular, this prevents wiper functions relevant or prescribed for safety from inadvertently becoming unavailable due to operation errors or programming errors. For example, this may be realized by separate memory regions, wherein at least one of the wiper functions activated by default is stored in a memory area that cannot be overwritten.

A subsequent activation or deactivation of program functions itself is known to the person skilled in the art, so that the necessary steps are not discussed in detail here. For this purpose, methods known in the vehicle sector in particular can be used, e.g., SOTA or FOTA (software or firmware over the air).

A programming device according to the invention is configured, in particular in terms of program technology, to perform a method according to the invention.

The implementation of a method according to the invention in the form of a computer program or computer program product comprising program code for carrying out all method steps is advantageous as well, because the associated costs are very low, in particular if an executing programming device is also used for other tasks and is therefore already available. Lastly, a machine-readable storage medium is provided, on which a computer program as described above is stored. Suitable storage media or data carriers for providing the computer program are in particular magnetic, optical and electrical memories, such as hard drives, flash memories, EEPROMs, DVDs, etc. Downloading a program via computer networks (Internet, intranet, etc.) is possible, too. Such a download can be wired or cabled or wireless (e.g., via a WLAN, a 3G, 4G, 5G, or 6G connection, etc.).

### BRIEF DESCRIPTION OF THE DRAWINGS

Further advantages and embodiments of the invention will emerge from the description and the accompanying drawing.

The invention is illustrated schematically in the drawing on the basis of exemplary embodiments and is described in the following with reference to said drawing.

FIG. 1 shows a block diagram of a windshield wiper system with a control device according to one embodiment of the invention.

FIG. 2 shows a block diagram of a sequence of a programming operation of a control device according to one embodiment of the invention.

### DETAILED DESCRIPTION

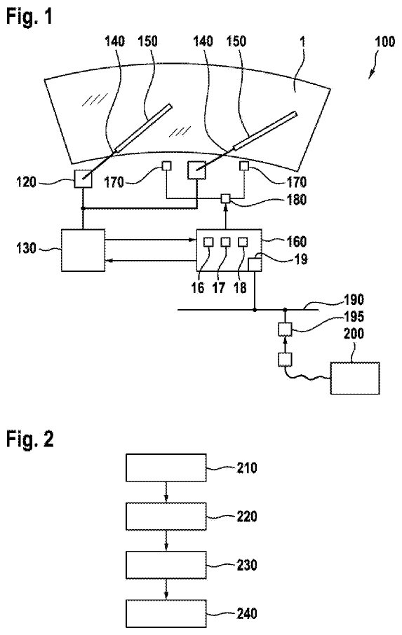

FIG. 1 shows an exemplary windshield wiper system 100, as it is typically used on a front windshield 1 of a motor vehicle. The windshield wiper system 100 comprises two wiper arms 140, each of which abuts a wiper blade 150 attached thereto on the windshield 1 to be cleaned. The pair of wiper arms 140 are often driven by a common power unit 120, wherein, in the present example, each wiper arm 140 has its own drive unit 120. A typical drive unit 120 may include a rotary motor or a reversing wiper motor coupled to the respective wiper arm 140 directly or via a suitable transmission (not shown here). In operation, the drive unit 120 drives the associated wiper arm 140 such that the wiper blade 150 sweeps over the surface of the windshield 1, removing moisture and other misting from the surface of the windshield.

Furthermore, the windshield wiper system 100 includes two spray nozzles 170 that are supplied with spray water by a water pump 180.

To control each drive unit 120 and the water pump 180, the windshield wiper system 100 includes a control unit 160, and, if necessary, a driver unit 130 downstream of the control unit 160.

On the one hand, the control unit 160 specifies how often and at what speed the wiper arms 140 are moved over the windshield 1. This is usually done via a manipulated variable that the controller 160 provides to the driver unit 130. The driver unit 130 converts this manipulated variable into a corresponding control variable for the drive units 120, for example one or more voltages or voltage pulses, which generate the desired driving torque or the desired speed in the drive unit 120. For example, controlling the power units 120 is accomplished using pulse width modulated signals. Alternatively, only a wiping frequency may be specified as the manipulated variable, from which the driver unit 130 determines the corresponding control variables for the respective drive unit 120 in order to drive it in such a way that the wiping arm 140 is operated at the predetermined wiping frequency.

The control unit 160, on the other hand, specifies how long, and if so, at what speed, the water pump 180 delivers water and feeds it to the spray nozzles. For this purpose, the water pump may be supplied with energy directly from the control unit 160 for conveying, or the water pump may include a driver unit that is controlled by the control unit.

The controller 160 comprises a CPU as a computing unit 16, (volatile) main memory 17, flash memory as a nonvolatile memory unit 18, and a programming interface 19.

The nonvolatile memory unit 18 is used for storing computer programs, software, data, and the like. The computing unit 16 can be any central processing unit, microprocessor, or controller for use in a computer system. It is used to execute the programs stored in the nonvolatile memory unit 18. The computing unit 16 can typically read from and write to the main memory 17 and the nonvolatile memory unit 18.

The control unit 160 comprises a programming interface 19, which in the present case is connected to a communication system 190 of the vehicle for data transmission, e.g., a CAN bus, which in turn is externally accessible via an interface 195, e.g., a so-called OBD interface. Alternatively, the programming interface of the control unit itself may also be based on a device interface, for example in the form of conventional interfaces such as Ethernet, USB, FlexRay, etc. Wireless access via a remote communication module may also be provided in the control unit 160 or in the communication system 190.

The remote communication module may be configured to communicate wirelessly via local area networks (LANs), such as Wireless LAN (WiFi/WLAN), or via wide area networks (WANs) such as Global System for Mobile Communication (GSM), General Package Radio Service (GPRS), Enhanced Data Rates for Global Evolution (EDGE), Universal Mobile Telecommunications System (UMTS), High Speed Downlink/Uplink Packet Access (HSDPA, HSUPA), Long-Term Evolution (LTE), or World Wide Interoperability for Microwave Access (WIMAX). Communication via other common or future communication technologies, e.g., 5G mobile radio systems, is possible.

In particular, a programming device 200 may be plugged into or communicate wirelessly with the OBD interface or the device interface to program the control unit 160, as exemplified below with reference to FIG. 2.

In a step 210, the programming device 200 is indirectly or directly connected to the programming interface 19. The programming device 200 may be a specific programming device for a vehicle environment or a conventional PC or laptop.

In a step 220, which may also take place before step 210, corresponding programming software is started on the programming device 200.

In a step 230, an operator or programmer selects a wiper function to be activated (or deactivated, which is also possible in principle) in the programming software. This can be done using common human-machine interfaces such as a touch screen, mouse, keyboard, etc.

In a step 240, the programming device 200 accesses the control device 160 to modify the program stored in the nonvolatile memory unit 18 to make the wiping function selected in step 230 available (or deactivated) on the control device 160.

As a result, an operating control unit in the vehicle, for example a lever, may actuate the wiper system 100 to perform the newly added wiper function.

In one embodiment of the invention, a simple and reliable way of subsequently adding or activating certain wiper functions to a wiper system already installed in the vehicle is thus presented.

1. A control device (160) for controlling a windshield wiper system (100), the control device (160) comprising
a computing unit (16),
a nonvolatile memory unit (18) including a program, and
a programming interface (19) via which the program stored in the nonvolatile memory unit (18) can be modified.

2. The control device (160) according to claim 1, wherein the program stored in the nonvolatile memory unit (18) includes wiper functions activated by default.

3. The control device (160) according to claim 1, wherein the program stored in the nonvolatile memory unit (18) contains at least one deactivated wiper function, which can be activated by modifying the program stored in the nonvolatile memory unit (18), and/or wherein the program stored in the nonvolatile memory unit (18) contains at least one activated wiping function, which has been subsequently activated by modifying the program stored in the nonvolatile memory unit (18).

4. The control device (160) according to claim 2, wherein at least one of the wiper functions activated by default cannot be deactivated by modifying the program stored in the nonvolatile memory unit (18).

5. The method for programming a control device (160) according to claim l, wherein a programming device (200) is connected to the programming interface (19) for data transmission and the program stored in the nonvolatile memory unit (18) is modified while the control device (160) is installed in a vehicle.

6. The method according to claim 5, wherein modifying the program stored in the nonvolatile memory unit (18) comprises activating a wiper function already included in the program.

7. The method according to claim 5, wherein modifying the program stored in the nonvolatile memory unit (18) comprises adding program code of a wiping function to the program stored in the nonvolatile memory unit (18).

8. The method according to claim 6, wherein the wiper function comprises a zone cleaning of sensors, power splash wiping, tear wiping, dirt wedge wiping, and a predictive maintenance function.

9. A programming unit (200) which is configured to perform all method steps of a method according to claim 5.

10. (canceled)

11. A non-transitory, computer-readable medium containing instructions that when executed by a computer cause the computer to
connect to a programming interface (19) for data transmission, and
modify a program stored in a nonvolatile memory unit (18) while the computer is installed in a vehicle.
